(19) United States
(12) Patent Application Publication
(10) Pub. No.: US 2017/0161765 A1
(43) Pub. Date: Jun. 8, 2017

(54) SYSTEM FOR EXCHANGING ENVIRONMENTAL DATA

(71) Applicant: Elwha LLC, Bellevue, WA (US)

(72) Inventors: Jesse R. Cheatham, III, Seattle, WA (US); William David Duncan, Mill Creek, WA (US); Roderick A. Hyde, Redmond, WA (US); Muriel Y. Ishikawa, Livermore, CA (US); Thomas Allan Weaver, San Mateo, CA (US); Lowell L. Wood, JR., Bellevue, WA (US)

(21) Appl. No.: 14/958,549

(22) Filed: Dec. 3, 2015

(51) Int. Cl. G06Q 30/02; H04L 29/08

(52) U.S. Cl. CPC G06Q 30/0208; H04L 67/06

(57) ABSTRACT

Described embodiments include a system, method, and article of manufacture. An environmental-data exchange system includes circuitry for receiving a data request originated by a requesting mobile apparatus, the data request including data indicative of a specified attribute of an operational environment of the requesting mobile apparatus. The system includes circuitry for receiving a data offer originated by a responding apparatus, the data offer including supplying the requested data indicative of the specified attribute of the operational environment of the requesting mobile apparatus. The system includes circuitry for forming an agreement between the requesting mobile apparatus and the responding apparatus, the agreement including the responding apparatus transmitting the requested data indicative of the specified attribute of the environment in exchange for compensation. The system includes circuitry for initiating implementation of the agreement between the requesting mobile apparatus and the responding apparatus.

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### CROSS-REFERENCE TO RELATED APPLICATIONS

The present application claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)). In addition, the present application is related to the “Related Applications,” if any, listed below.

### PRIORITY APPLICATIONS

None.

If the listings of applications provided above are inconsistent with the listings provided via an ADS, it is the intent of the Applicant to claim priority to each application that appears in the Priority Applications section of the ADS and to each application that appears in the Priority Applications section of this application.

All subject matter of the Priority Applications and the Related Applications and of any and all parent, grandparent, great-grandparent, etc. applications of the Priority Applications and the Related Applications, including any priority claims, is incorporated herein by reference to the extent such subject matter is not inconsistent herewith.

### SUMMARY

For example, and without limitation, an embodiment of the subject matter described herein includes an environmental-data exchange system. The system includes circuitry for receiving a data request originated by a requesting mobile apparatus, the data request including data indicative of a specified attribute of an operational environment of the requesting mobile apparatus. The system includes circuitry for receiving a data offer originated by a responding apparatus, the data offer including supplying the requested data indicative of the specified attribute of the operational environment of the requesting mobile apparatus. The system includes circuitry for forming an agreement between the requesting mobile apparatus and the responding apparatus, the agreement including the responding apparatus transmitting the requested data indicative of the specified attribute of the environment in exchange for compensation. The system includes circuitry for initiating implementation of the agreement between the requesting mobile apparatus and the responding apparatus.

In an embodiment, the system includes circuitry for sending a data request, the sent data request including data indicative of the specified attribute of the operational environment of the requesting mobile apparatus. In an embodiment, the system includes circuitry for searching a database of respective offers of data directed to a particular attribute of a particular environment originated by at least two responding apparatus for a conformance with the mobile apparatus data request; and wherein the circuitry for forming an agreement includes circuitry for forming an agreement between the requesting mobile apparatus and the responding apparatus that offered the data conforming to the data request. In an embodiment, the system includes circuitry for initiating a transfer of the compensation to the responding apparatus or the system. In an embodiment, the system includes circuitry for selecting an offer to supply the requested data originated by a responding apparatus of at least two responding apparatus; and wherein the circuitry for forming an agreement includes circuitry for forming an agreement between the requesting mobile apparatus and the responding apparatus originating the selected offer to supply the requested data.

For example, and without limitation, an embodiment of the subject matter described herein includes a computationally-implemented method. The method includes receiving a data request originated by a requesting mobile apparatus, the data request including data indicative of a specified attribute of an operational environment of the mobile apparatus. The method includes receiving a data offer originated by a responding apparatus, the data offer including supplying the requested data indicative of the specified attribute of the operational environment of the requesting mobile apparatus. The method includes determining if the data offer is responsive to the data request. The method includes forming an agreement between the requesting mobile apparatus and the responding apparatus, the agreement including the responding apparatus transmitting the requested data indicative of the specified attribute of the environment in exchange for compensation. The method includes initiating implementation of the agreement between the requesting mobile apparatus and the responding apparatus.

In an embodiment, the computationally-implemented method includes sending a data request, the sent data request including data indicative of the specified attribute of the operational environment of the requesting mobile apparatus. In an embodiment, the method includes searching a database of respective offers of data directed to a particular attribute of a particular environment originated by at least two responding apparatus for a conformance with the mobile apparatus data request; and wherein the forming an agreement includes forming an agreement between the requesting mobile apparatus and the responding apparatus that offered the data conforming to the data request. In an embodiment, the method includes initiating a transfer of the compensation. In an embodiment, the method includes selecting an offer to supply the requested data originated by a responding apparatus of at least two responding apparatus; and wherein the forming an agreement includes forming an agreement between the requesting mobile apparatus and the responding apparatus originating the selected offer to supply the requested data.

For example, and without limitation, an embodiment of the subject matter described herein includes an article of manufacture. The article of manufacture includes a non-transitory storage medium. The non-transitory storage medium bearing one or more instructions for receiving a data request originated by a requesting mobile apparatus, the data request including data indicative of a specified attribute of an operational environment of the mobile apparatus. The non-transitory storage medium bearing one or more instructions for receiving a data offer originated by a responding apparatus, the data offer including supplying the requested data indicative of the specified attribute of the operational environment of the requesting mobile apparatus. The non-transitory storage medium bearing one or more instructions for forming an agreement between the requesting mobile apparatus and the responding apparatus, the agreement including the responding apparatus transmitting the requested data indicative of the specified attribute of the environment in exchange for a compensation. The non-transitory storage medium bearing one or more instructions for initiating implementation of the agreement between the requesting mobile apparatus and the responding apparatus.

In an embodiment of the article of manufacture, the non-transitory storage medium bears one or more instructions for sending a data request, the sent data request including data indicative of the specified attribute of the operational environment of the requesting mobile apparatus. In an embodiment of the article of manufacture, the non-transitory storage medium bears one or more instructions for searching a database of respective offers of data directed to a particular attribute of a particular environment originated by at least two responding apparatus for a conformance with the mobile apparatus data request; and wherein the one or more instructions for forming an agreement include one or more instructions for forming an agreement between the requesting mobile apparatus and the responding apparatus that offered the data conforming to the data request. In an embodiment of the article of manufacture, the non-transitory storage medium bears one or more instructions for initiating a transfer of the compensation. In an embodiment of the article of manufacture, the non-transitory storage medium bears one or more instructions for selecting an offer to supply the requested data originated by a responding apparatus of at least two responding apparatus; and wherein the one or more instructions for forming an agreement include one or more instructions for forming an agreement between the requesting mobile apparatus and the responding apparatus originating the selected offer to supply the requested data.

For example, and without limitation, an embodiment of the subject matter described herein includes a system in the form of a machine, article of manufacture, or composition of matter. The system includes a first receiver module configured to electronically receive a data request originated by a requesting mobile apparatus, the data request including data indicative of a specified attribute of an operational environment of the mobile apparatus. The system includes a second receiver module configured to electronically receive a data offer originated by a responding apparatus, the data offer including supplying the requested data indicative of the specified attribute of the operational environment of the requesting mobile apparatus. The system includes a contract module configured to electronically form an agreement between the requesting mobile apparatus and the responding apparatus, the agreement including the responding apparatus transmitting the requested data indicative of the specified attribute of the environment in exchange for compensation. The system includes a fulfillment module configured to electronically initiate implementation of the agreement between the requesting mobile apparatus and the responding apparatus.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 illustrates an example embodiment of an environment 19 that includes a thin computing device 20 in which embodiments may be implemented;

FIG. 2 illustrates an example embodiment of an environment 100 that includes a general-purpose computing system 110 in which embodiments may be implemented;

FIG. 3 schematically illustrates an example environment 200 in which embodiments may be implemented;

FIG. 4 schematically illustrates an example of the mobile apparatus 210;

FIG. 5 illustrates an example article of manufacture 300 that includes a non-transitory storage medium 310;

FIG. 6 illustrates an example system 400 in the form of a machine, article of manufacture, or composition of matter;

FIG. 7 illustrates computationally-implemented operational flow 500;

FIG. 8 illustrates an example of the responding apparatus 610 described in conjunction with FIGS. 3 and 4;

FIG. 9 illustrates an example computationally-implemented operational flow 700;

FIG. 10 schematically illustrates an alternative embodiment 800 of the example environment 200 in which embodiments may be implemented;

FIG. 11 schematically illustrates an example of the environmental-data exchange system 810;

FIG. 12 illustrates an example computationally-implemented operational flow 900; and

FIG. 13 illustrates an example article of manufacture 1000 that includes a non-transitory storage medium 1010

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Related Applications:

This application makes reference to technologies described more fully in U.S. patent application Ser. No. 13/402,737, entitled SYSTEMS AND METHODS FOR ACCESSING CAMERA SYSTEMS, naming William David Duncan et al. as inventors, filed on 22 Feb. 2012, is related to the present application. That application is incorporated by reference here in, including any subject matter included by reference in that application.

This application makes reference to technologies described more fully in U.S. patent application Ser. No. 13/402,740, entitled SYSTEMS AND METHODS FOR ACCESSING CAMERA SYSTEMS, naming William David Duncan et al. as inventors, filed on 22 Feb. 2012, is related to the present application. That application is incorporated by reference here in, including any subject matter included by reference in that application.

This application makes reference to technologies described more fully in U.S. patent application Ser. No. 13/402,744, entitled SYSTEMS AND METHODS FOR ACCESSING CAMERA SYSTEMS, naming William David Duncan et al. as inventors, filed on 22 Feb. 2012, is related to the present application. That application is incorporated by reference here in, including any subject matter included by reference in that application.

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various implementations by which processes and/or systems and/or other technologies described herein can be effected (e.g., hardware, software, and/or firmware), and that the preferred implementation will vary with the context in which the processes and/or systems and/or other technologies are deployed. For example, if an implementer determines that speed and accuracy are paramount, the implementer may opt for a mainly hardware and/or firmware implementation; alternatively, if flexibility is paramount, the implementer may opt for a mainly software implementation; or, yet again alternatively, the implementer may opt for some combination of hardware, software, and/or firmware. Hence, there are several possible implementations by which the processes and/or devices and/or other technologies described herein may be effected, none of which is inherently superior to the other in that any implementation to be utilized is a choice dependent upon the context in which the implementation will be deployed and the specific concerns (e.g., speed, flexibility, or predictability) of the implementer, any of which may vary. Those skilled in the art will recognize that optical aspects of implementations will typically employ optically-oriented hardware, software, and or firmware.

In some implementations described herein, logic and similar implementations may include software or other control structures suitable to implement an operation. Electronic circuitry, for example, may manifest one or more paths of electrical current constructed and arranged to implement various logic functions as described herein. In some implementations, one or more media are configured to bear a device-detectable implementation if such media hold or transmit a special-purpose device instruction set operable to perform as described herein. In some variants, for example, this may manifest as an update or other modification of existing software or firmware, or of gate arrays or other programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively or additionally, implementations may include executing a special-purpose instruction sequence or otherwise invoking circuitry for enabling, triggering, coordinating, requesting, or otherwise causing one or more occurrences of any functional operations described below. In some variants, operational or other logical descriptions herein may be expressed directly as source code and compiled or otherwise invoked as an executable instruction sequence. In some contexts, for example, C++ or other code sequences can be compiled directly or otherwise implemented in high-level descriptor languages (e.g., a logic-synthesizable language, a hardware description language, a hardware design simulation, and/or other such similar mode(s) of expression). Alternatively or additionally, some or all of the logical expression may be manifested as a Verilog-type hardware description or other circuitry model before physical implementation in hardware, especially for basic operations or timing-critical applications. Those skilled in the art will recognize how to obtain, configure, and optimize suitable transmission or computational elements, material supplies, actuators, or other common structures in light of these teachings.

In a general sense, those skilled in the art will recognize that the various embodiments described herein can be implemented, individually and/or collectively, by various types of electro-mechanical systems having a wide range of electrical components such as hardware, software, firmware, and/or virtually any combination thereof and a wide range of components that may impart mechanical force or motion such as rigid bodies, spring or torsional bodies, hydraulics, electro-magnetically actuated devices, and/or virtually any combination thereof. Consequently, as used herein “electro-mechanical system” includes, but is not limited to, electrical circuitry operably coupled with a transducer (e.g., an actuator, a motor, a piezoelectric crystal, a Micro Electro Mechanical System (MEMS), etc.), electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), electrical circuitry forming a communications device (e.g., a modem, module, communications switch, optical-electrical equipment, etc.), and/or any non-electrical analog thereto, such as optical or other analogs. Those skilled in the art will also appreciate that examples of electro-mechanical systems include but are not limited to a variety of consumer electronics systems, medical devices, as well as other systems such as motorized transport systems, factory automation systems, security systems, and/or communication/computing systems. Those skilled in the art will recognize that electro-mechanical as used herein is not necessarily limited to a system that has both electrical and mechanical actuation except as context may dictate otherwise.

In a general sense, those skilled in the art will also recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those having skill in the art will recognize that the subject matter described herein may be implemented in an analog or digital fashion or some combination thereof.

Those skilled in the art will further recognize that at least a portion of the devices and/or processes described herein can be integrated into an image processing system. A typical image processing system may generally include one or more of a system unit housing, a video display device, memory such as volatile or non-volatile memory, processors such as microprocessors or digital signal processors, computational entities such as operating systems, drivers, applications programs, one or more interaction devices (e.g., a touch pad, a touch-sensitive screen or display surface, an antenna, etc.), control systems including feedback loops and control motors (e.g., feedback for sensing lens position and/or velocity; control motors for moving/distorting lenses to give desired focuses). An image processing system may be implemented utilizing suitable commercially available components, such as those typically found in digital still systems and/or digital motion systems.

Those skilled in the art will likewise recognize that at least some of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch-sensitive screen or display surface, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

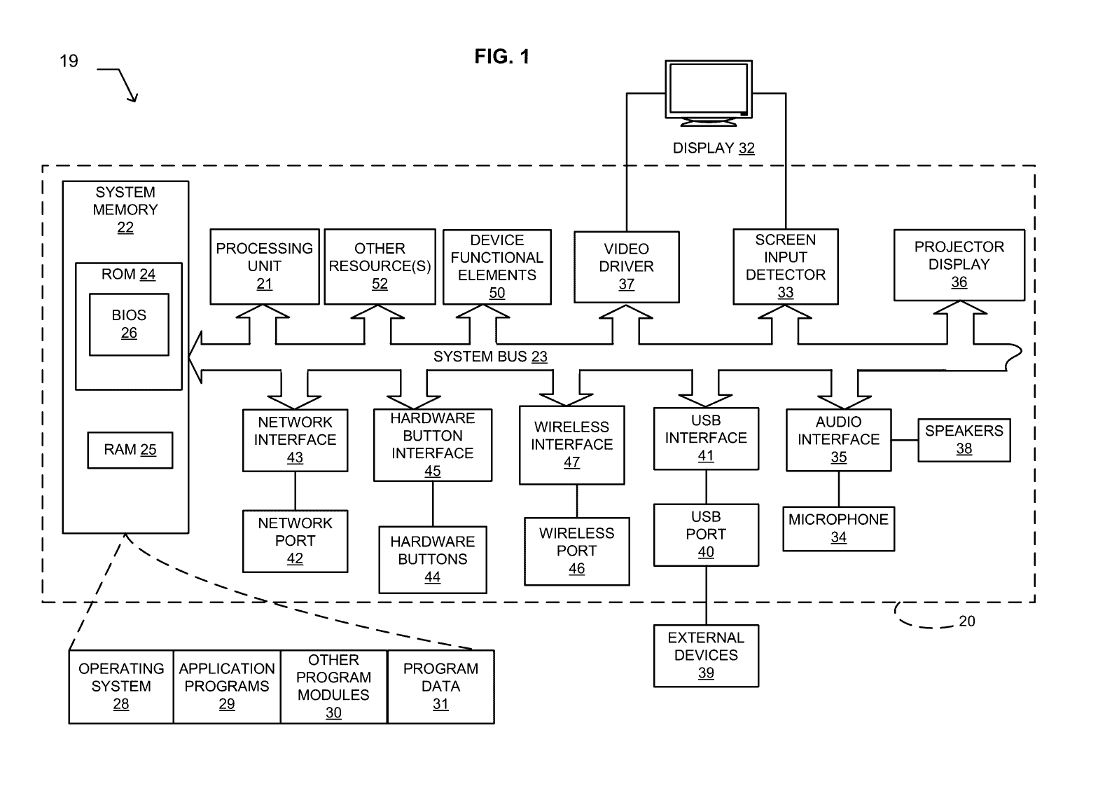

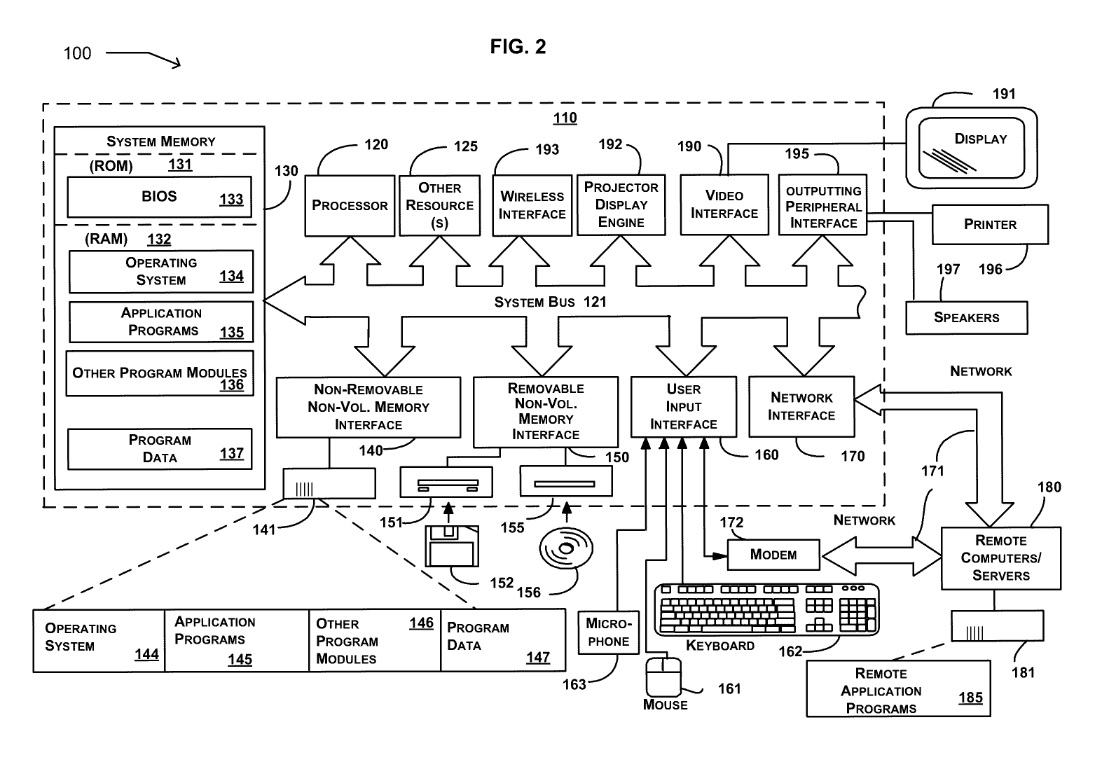

FIGS. 1 and 2 provide respective general descriptions of several environments in which implementations may be implemented. FIG. 1 is generally directed toward a thin computing environment 19 having a thin computing device 20, and FIG. 2 is generally directed toward a general purpose computing environment 100 having general purpose computing device 110. However, as prices of computer components drop and as capacity and speeds increase, there is not always a bright line between a thin computing device and a general purpose computing device. Further, there is a continuous stream of new ideas and applications for environments benefited by use of computing power. As a result, nothing should be construed to limit disclosed subject matter herein to a specific computing environment unless limited by express language.

FIG. 1 and the following discussion are intended to provide a brief, general description of a thin computing environment 19 in which embodiments may be implemented. FIG. 1 illustrates an example system that includes a thin computing device 20, which may be included or embedded in an electronic device that also includes a device functional element 50. For example, the electronic device may include any item having electrical or electronic components playing a role in a functionality of the item, such as for example, a refrigerator, a car, a digital image acquisition device, a camera, a cable modem, a printer an ultrasound device, an x-ray machine, a non-invasive imaging device, or an airplane. For example, the electronic device may include any item that interfaces with or controls a functional element of the item. In another example, the thin computing device may be included in an implantable medical apparatus or device. In a further example, the thin computing device may be operable to communicate with an implantable or implanted medical apparatus. For example, a thin computing device may include a computing device having limited resources or limited processing capability, such as a limited resource computing device, a wireless communication device, a mobile wireless communication device, a smart phone, an electronic pen, a handheld electronic writing device, a scanner, a cell phone, a smart phone (such as an Android® or iPhone® based device), a tablet device (such as an iPad®) or a Blackberry® device. For example, a thin computing device may include a thin client device or a mobile thin client device, such as a smart phone, tablet, notebook, or desktop hardware configured to function in a virtualized environment.

The thin computing device 20 includes a processing unit 21, a system memory 22, and a system bus 23 that couples various system components including the system memory 22 to the processing unit 21. The system bus 23 may be any of several types of bus structures including a memory bus or memory controller, a peripheral bus, and a local bus using any of a variety of bus architectures. The system memory includes read-only memory (ROM) 24 and random access memory (RAM) 25. A basic input/output system (BIOS) 26, containing the basic routines that help to transfer information between sub-components within the thin computing device 20, such as during start-up, is stored in the ROM 24. A number of program modules may be stored in the ROM 24 or RAM 25, including an operating system 28, one or more application programs 29, other program modules 30 and program data 31.

A user may enter commands and information into the computing device 20 through one or more input interfaces. An input interface may include a touch-sensitive screen or display surface, or one or more switches or buttons with suitable input detection circuitry. A touch-sensitive screen or display surface is illustrated as a touch-sensitive display 32 and screen input detector 33. One or more switches or buttons are illustrated as hardware buttons 44 connected to the system via a hardware button interface 45. The output circuitry of the touch-sensitive display 32 is connected to the system bus 23 via a video driver 37. Other input devices may include a microphone 34 connected through a suitable audio interface 35, or a physical hardware keyboard (not shown). Output devices may include the display 32, or a projector display 36.

In addition to the display 32, the computing device 20 may include other peripheral output devices, such as at least one speaker 38. Other external input or output devices 39, such as a joystick, game pad, satellite dish, scanner or the like may be connected to the processing unit 21 through a USB port 40 and USB port interface 41, to the system bus 23. Alternatively, the other external input and output devices 39 may be connected by other interfaces, such as a parallel port, game port or other port. The computing device 20 may further include or be capable of connecting to a flash card memory (not shown) through an appropriate connection port (not shown). The computing device 20 may further include or be capable of connecting with a network through a network port 42 and network interface 43, and through wireless port 46 and corresponding wireless interface 47 may be provided to facilitate communication with other peripheral devices, including other computers, printers, and so on (not shown). It will be appreciated that the various components and connections shown are examples and other components and means of establishing communication links may be used.

The computing device 20 may be primarily designed to include a user interface. The user interface may include a character, a key-based, or another user data input via the touch sensitive display 32. The user interface may include using a stylus (not shown). Moreover, the user interface is not limited to an actual touch-sensitive panel arranged for directly receiving input, but may alternatively or in addition respond to another input device such as the microphone 34. For example, spoken words may be received at the microphone 34 and recognized. Alternatively, the computing device 20 may be designed to include a user interface having a physical keyboard (not shown).

The device functional elements 50 are typically application specific and related to a function of the electronic device, and are coupled with the system bus 23 through an interface (not shown). The computing device may include other resource(s) 52. The functional elements may typically perform a single well-defined task with little or no user configuration or setup, such as a refrigerator keeping food cold, a cell phone connecting with an appropriate tower and transceiving voice or data information, a camera capturing and saving an image, or communicating with an implantable medical apparatus.

In certain instances, one or more elements of the thin computing device 20 may be deemed not necessary and omitted. In other instances, one or more other elements may be deemed necessary and added to the thin computing device.

FIG. 2 and the following discussion are intended to provide a brief, general description of an environment in which embodiments may be implemented. FIG. 2 illustrates an example embodiment of a general-purpose computing system in which embodiments may be implemented, shown as a computing system environment 100. Components of the computing system environment 100 may include, but are not limited to, a general purpose computing device 110 having a processor 120, a system memory 130, and a system bus 121 that couples various system components including the system memory to the processor 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

The computing system environment 100 typically includes a variety of computer-readable media products. Computer-readable media may include any media that can be accessed by the computing device 110 and include non-transitory media, both volatile and nonvolatile media, and removable and non-removable media. By way of example, and not of limitation, computer-readable media may include computer storage media.

Computer storage media includes nonvolatile, removable and non-removable media implemented in any method or technology for storage of information such as computer-readable instructions, data structures, program modules, or other data. Computer storage media includes, but is not limited to, random-access memory (RAM), read-only memory (ROM), electrically erasable programmable read-only memory (EEPROM), flash memory, or other memory technology, CD-ROM, digital versatile disks (DVD), or other optical disk storage, magnetic cassettes, magnetic tape, magnetic disk storage, or other magnetic storage devices, or any other medium which can be used to store the desired information and which can be accessed by the computing device 110. In a further embodiment, a computer storage media may include a group of computer storage media devices. In another embodiment, a computer storage media may include an information store. In another embodiment, an information store may include a quantum memory, a photonic quantum memory, or atomic quantum memory. Combinations of any of the above may also be included within the scope of computer-readable media.

The system memory 130 includes computer storage media in the form of volatile and nonvolatile memory such as ROM 131 and RAM 132. A RAM may include at least one of a DRAM, an EDO DRAM, a SDRAM, a RDRAM, a VRAM, or a DDR DRAM. A basic input/output system (BIOS) 133, containing the basic routines that help to transfer information between elements within the computing device 110, such as during start-up, is typically stored in ROM 131. RAM 132 typically contains data and program modules that are immediately accessible to or presently being operated on by the processor 120. By way of example, and not limitation, FIG. 2 illustrates an operating system 134, application programs 135, other program modules 136, and program data 137. Often, the operating system 134 offers services to applications programs 135 by way of one or more application programming interfaces (APIs) (not shown). Because the operating system 134 incorporates these services, developers of applications programs 135 need not redevelop code to use the services. Examples of APIs provided by operating systems such as Microsoft's “WINDOWS” ® are well known in the art.

The computing device 110 may also include other removable/non-removable, volatile/nonvolatile computer storage media products. By way of example only, FIG. 2 illustrates a non-removable non-volatile memory interface (hard disk interface) 140 that reads from and writes for example to non-removable, non-volatile magnetic media. FIG. 2 also illustrates a removable non-volatile memory interface 150 that, for example, is coupled to a magnetic disk drive 151 that reads from and writes to a removable, non-volatile magnetic disk 152, or is coupled to an optical disk drive 155 that reads from and writes to a removable, non-volatile optical disk 156, such as a CD ROM. Other removable/non-removable, volatile/non-volatile computer storage media that can be used in the example operating environment include, but are not limited to, magnetic tape cassettes, memory cards, flash memory cards, DVDs, digital video tape, solid state RAM, and solid state ROM. The hard disk drive 141 is typically connected to the system bus 121 through a non-removable memory interface, such as the interface 140, and magnetic disk drive 151 and optical disk drive 155 are typically connected to the system bus 121 by a removable non-volatile memory interface, such as interface 150. The computing device may include other resource(s) 125.

The drives and their associated computer storage media discussed above and illustrated in FIG. 2 provide storage of computer-readable instructions, data structures, program modules, and other data for the computing device 110. In FIG. 2, for example, hard disk drive 141 is illustrated as storing an operating system 144, application programs 145, other program modules 146, and program data 147. Note that these components can either be the same as or different from the operating system 134, application programs 135, other program modules 136, and program data 137. The operating system 144, application programs 145, other program modules 146, and program data 147 are given different numbers here to illustrate that, at a minimum, they are different copies.

A user may enter commands and information into the computing device 110 through input devices such as a microphone 163, keyboard 162, and pointing device 161, commonly referred to as a mouse, trackball, or touch pad. Other input devices (not shown) may include at least one of a touch-sensitive screen or display surface, joystick, game pad, satellite dish, and scanner. These and other input devices are often connected to the processor 120 through a user input interface 160 that is coupled to the system bus, but may be connected by other interface and bus structures, such as a parallel port, game port, or a universal serial bus (USB).

A display 191, such as a monitor or other type of display device or surface may be connected to the system bus 121 via an interface, such as a video interface 190. A projector display engine 192 that includes a projecting element may be coupled to the system bus. In addition to the display, the computing device 110 may also include other peripheral output devices such as speakers 197 and printer 196, which may be connected through an output peripheral interface 195.

The computing system environment 100 may operate in a networked environment using logical connections to one or more remote computers, such as a remote computer 180. The remote computer 180 may be a personal computer, a server, a router, a network PC, a peer device, or other common network node, and typically includes many or all of the elements described above relative to the computing device 110, although only a memory storage device 181 has been illustrated in FIG. 2. The network logical connections depicted in FIG. 2 include a local area network (LAN) and a wide area network (WAN), and may also include other networks such as a personal area network (PAN) (not shown). Such networking environments are commonplace in offices, enterprise-wide computer networks, intranets, and the Internet.

When used in a networking environment, the computing system environment 100 is connected to the network 171 through a network interface, such as the network interface 170, the modem 172, or the wireless interface 193. The network may include a LAN network environment, or a WAN network environment, such as the Internet. In a networked environment, program modules depicted relative to the computing device 110, or portions thereof, may be stored in a remote memory storage device. By way of example, and not limitation, FIG. 2 illustrates remote application programs 185 as residing on memory storage device 181. It will be appreciated that the network connections shown are examples and other means of establishing a communication link between the computers may be used.

In certain instances, one or more elements of the computing device 110 may be deemed not necessary and omitted. In other instances, one or more other elements may be deemed necessary and added to the computing device.

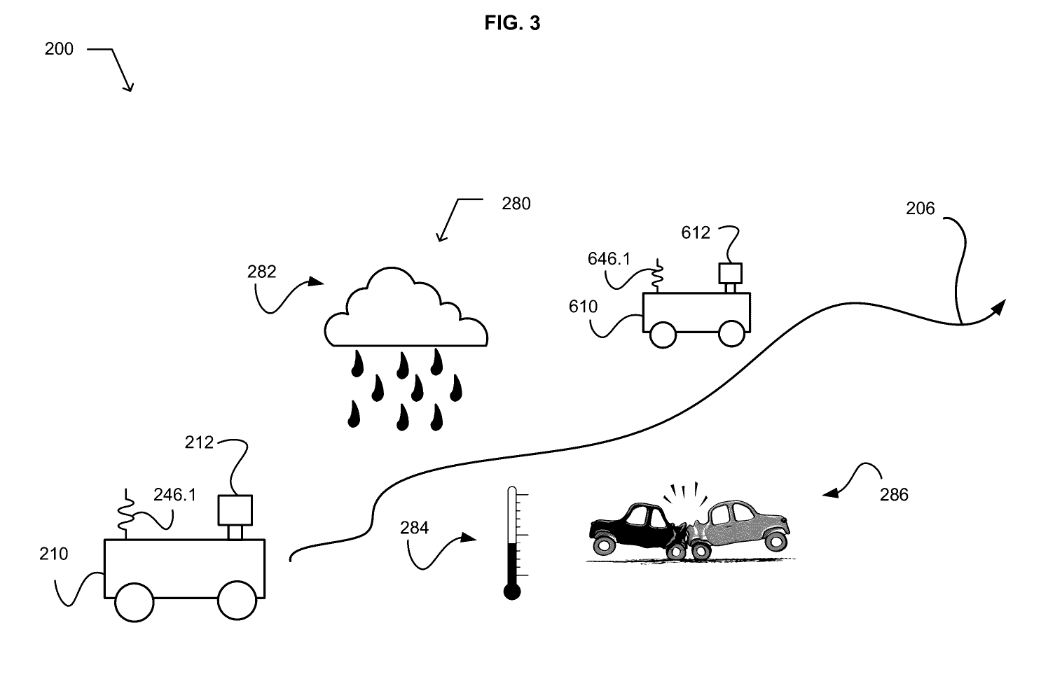

FIG. 3 schematically illustrates an example environment 200 in which embodiments may be implemented. The example environment includes a mobile apparatus 210. In an embodiment, the mobile apparatus is moving along a pathway 206. In an embodiment, the pathway may be road, an exterior pathway of an industrial premise, or an interior pathway of an industrial premise. The example environment includes an operational environment 280 of the mobile apparatus 210. Example attributes of the operational environment are illustrated by rain or snow 282, temperature 284, and an obstruction, illustrated by an automobile collision 286. The example environment 200 includes a responding apparatus 610. In an embodiment, the responding apparatus includes a sensor 612. In an embodiment, the responding apparatus includes wireless communication circuitry, illustrated in FIG. 3 by antenna 646.1.

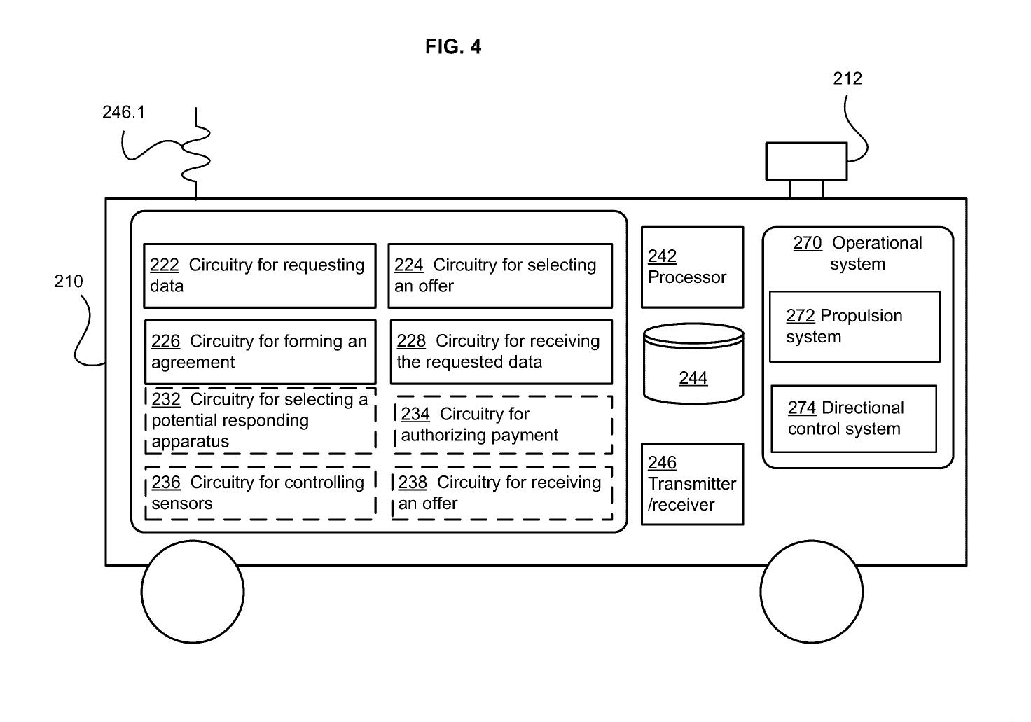

FIG. 4 schematically illustrates an example of the mobile apparatus 210. The mobile apparatus includes circuitry for requesting data 222 indicative of a specified attribute of the operational environment 280 of the mobile apparatus. In an embodiment, the specified attribute includes a specified present operational environment. In an embodiment, the specified attribute includes a specified future operational environment, such as 10 seconds, 30 seconds, one minute, or two minutes ahead for example. For example, a sensor 212 of the mobile apparatus may not be able to acquire the data indicative of the specified attribute, and thus initiates the request for data indicative of a specified attribute of the operational environment of the mobile apparatus by the circuitry for requesting 222. For example, the sensor may not be able to acquire the requested data because it is not sensitive to the requested data, because it cannot “see” around an obstacle, or an area of interest is too far away, the sensor not working, or additional detail is needed.

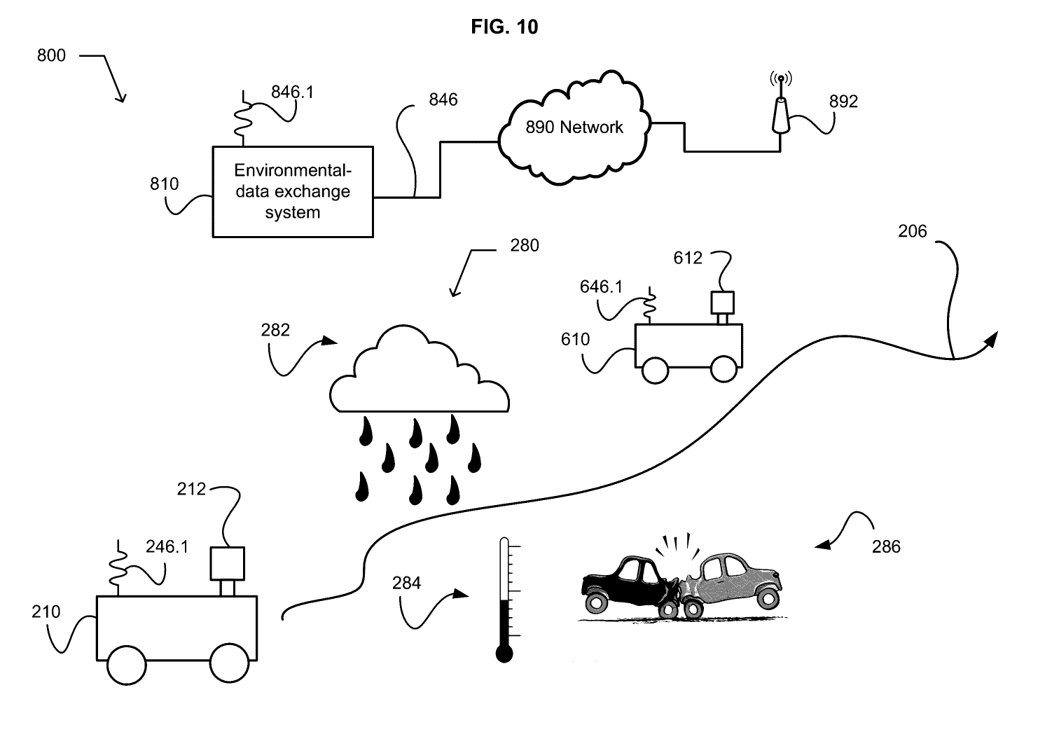

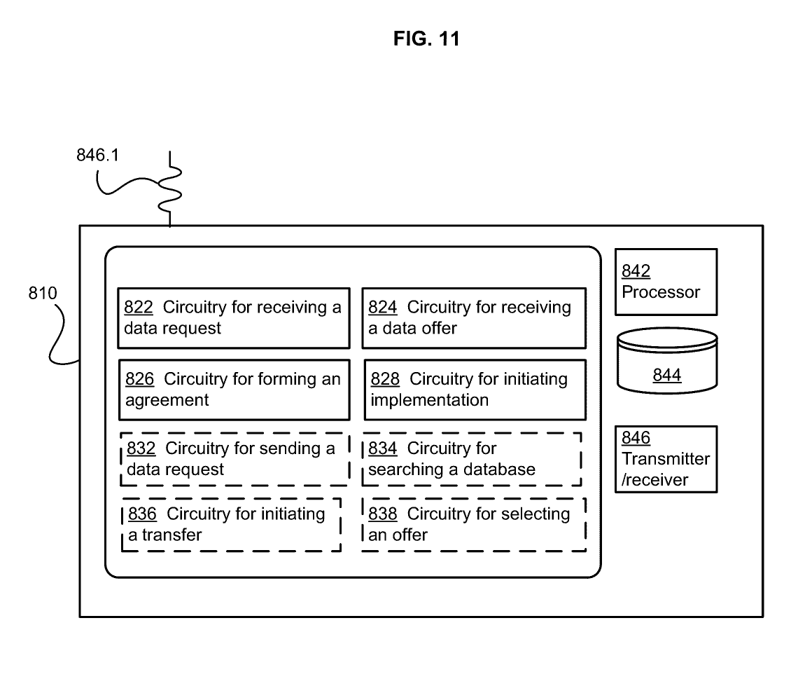

The mobile apparatus 210 includes circuitry for selecting an offer 224 submitted by a responding apparatus to supply the requested data indicative of the specified attribute of the operational environment of the mobile apparatus. For example, the response may be originated by the responding apparatus 610 described in conjunction with FIGS. 3, 4, and 8. For example, the request may be received from the environmental-data exchange 810 described in conjunction with FIGS. 10 and 11. In an embodiment, the circuitry for selecting includes circuitry for selecting an offer submitted by an identified responding apparatus to supply the requested data. In an embodiment, the circuitry for selecting includes circuitry for selecting an offer submitted by a sensor-equipped responding apparatus to supply the requested data. The mobile apparatus includes circuitry for forming an agreement 226 with the responding apparatus to supply the requested data. The mobile apparatus includes circuitry for receiving the requested data 228. In an embodiment, the circuitry for receiving includes circuitry for receiving the requested data from the responding apparatus. In an embodiment, the circuitry 228 includes circuitry for receiving the requested data from a third-party.

In an embodiment, the mobile apparatus 210 includes an operational system 270. In an embodiment, the operational system includes a propulsion system 272. In an embodiment, the propulsion system is configured to change a speed or a movement by the mobile apparatus based on the received requested data. In an embodiment, the mobile apparatus includes a directional control system 274. For example, a directional control system may include a steering system. In an embodiment, the directional control system is configured to change a direction of movement by the mobile apparatus based on the received requested data. In an embodiment, the operational system includes a system configured to change a state or configuration based on the received requested data. For example, the operational system may be configured to change a state or configuration by activating a human perceivable notification device, such as a flashing light. For example, the operational system may be configured to change a state or configuration of a deployable system. For example, a deployable system may include in an aircraft changing from a flying configuration to a landing configuration. For example, the operational system may be configured to change a state or configuration by changing the mobile apparatus from a driverless mode to a driver mode, or from a normal state to a hazard-alert state in response to received requested data indicative of snow, freezing rain, or car wreck.

In an embodiment, the mobile apparatus 210 includes a motor vehicle. In an embodiment, the mobile apparatus includes a car, truck, or train. In an embodiment, the mobile apparatus includes a ship, boat, or vessel. In an embodiment, the mobile apparatus includes an aircraft. For example, the aircraft may include a drone or a human-piloted aircraft. In an embodiment, the mobile apparatus includes a walking vehicle. In an embodiment, the mobile apparatus includes a semi-robotic or robotic vehicle. For example, the semi-robotic or robotic vehicle may include a walking vehicle, a wheeled or treaded vehicle, a drone, or a fixed industrial robot. In an embodiment, the mobile apparatus includes a human-controlled vehicle.

In an embodiment of the mobile apparatus 210, the circuitry for requesting 222 includes circuitry for requesting data indicative of the specified attribute of the operational environment 280 of the mobile apparatus from a potential responding apparatus. For example, the potential responding apparatus may include the apparatus 610. In an embodiment, the circuitry for requesting includes circuitry for requesting data indicative of the specified attribute of an operational environment of the mobile apparatus from a selected potential responding apparatus.

In an embodiment of the mobile apparatus 210, further includes circuitry for selecting 232 a potential responding apparatus. In an embodiment, the selecting the potential responding apparatus is responsive to a vantage point of a potential responding apparatus. For example, a vantage point may include a position, orientation, or perspective. In an embodiment, the selecting the potential responding apparatus is responsive to proximity of the potential responding apparatus to the mobile apparatus. In an embodiment, the selecting the potential responding apparatus is responsive to proximity of the potential responding apparatus to the route 206 of the mobile apparatus. In an embodiment, the selecting the potential responding apparatus is responsive to a route of the potential responding apparatus. For example, responsive to the route of the potential responding apparatus may include a location, position, or orientation of the potential responding apparatus at a past, a present, or a future time. In an embodiment, the selecting the potential responding apparatus is responsive to a radio signal or optical visibility of the potential responding apparatus to the mobile apparatus. (e.g., I can see it or hear it). In an embodiment, the selecting the potential responding apparatus is responsive to a type or capability of a sensor carried by the potential responding apparatus. For example, a capability may include uplink bandwidth. In an embodiment, the selecting the potential responding apparatus is responsive to an identity of the potential responding apparatus. For example, the identity of the potential responding apparatus may establish that the mobile apparatus has dealt with the potential responding apparatus in the past. For example, the identity of the potential responding apparatus may establish that the potential responding apparatus is of a given make or model, or one having a preferred affiliation. For example, a preferred affiliation may include an organization or association that the mobile apparatus has an agreement with. In an embodiment, the selecting the potential responding apparatus is responsive to an indication of availability of the potential responding apparatus. For example, a potential responding apparatus may broadcast a signal, post a flag on website, or be listed on a database. In an embodiment, the selecting the potential responding apparatus is responsive to an announcement of an availability and of an environmental-data sensor acquisition capability of the potential responding apparatus. In an embodiment, the selecting the potential responding apparatus is responsive to information related to a location, route, or sensor capability of the potential responding apparatus. In an embodiment, the selecting the potential responding apparatus is responsive to a database of potential responding apparatus. For example, the database may be locally stored on a computer-readable media, illustrated by a storage device 244. For example, the database may be a centralized database or a third-party database. For example, the database may include a current location of the responding apparatus 610, and locations of other mobile or stationary potential responding apparatus. For example, the database may include sensor capabilities of the potential responding apparatus.

In an embodiment, the mobile apparatus 210 includes a central processing unit or processor 242. For example, the processor may be similar to the processing unit 21 described in conjunction with FIG. 1. In an embodiment, the mobile apparatus may include at least one element or component of the thin computing device 20 described in conjunction with FIG. 1. For example, the processor may be similar to the processor 120 described in conjunction with FIG. 2. In an embodiment, the mobile apparatus may include at least one element or component of the general purpose computing system 110 described in conjunction with FIG. 2.

In an embodiment of the mobile apparatus 210, the circuitry for requesting 222 includes circuitry for requesting data indicative of the operational environment 280 of the mobile apparatus from a monetized environmental data exchange system. For example, the monetized environmental data exchange system may include a networked data exchange system. For example, the monetized environmental data exchange system may include a cash or a barter based system. In an embodiment, the circuitry for requesting includes circuitry for requesting data indicative of the operational environment of the mobile apparatus from another mobile apparatus. In an embodiment, the circuitry for requesting includes circuitry for automatically requesting data indicative of the operational environment of the mobile apparatus. In an embodiment, the circuitry for requesting includes circuitry for requesting in response to a human input data indicative of the operational environment of the mobile apparatus. In an embodiment, the requested data includes sensor acquired data indicative of the operational environment of the mobile apparatus. For example, the requested data may include present or future acquired sensor data. For example, the sensor data may include data acquired by an imaging, radar, LIDAR acoustic, ultrasound, thermocouple, or moisture sensors. For example, sensor data may be real-time or historical data (i.e., within last 30 minutes). In an embodiment, the specified attribute of the operational environment of the mobile apparatus includes route-condition related data. In an embodiment, the specified attribute of the operational environment of the mobile apparatus includes a temperature, visibility, road surface condition, congestion, obstruction, or radar traps. In an embodiment, the specified attribute of the operational environment includes a route condition data. In an embodiment, the specified attribute of the operational environment includes a timeliness of the data. For example, the timeliness may include a time age specification or limitation. For example, the timeliness may include a specific time, past, present, or future. In an embodiment, the specified attribute of the operational environment includes a confidence level in the data indicative of the specified attribute of an operational environment. In an embodiment, the specified attribute of the operational environment includes the specified attribute of an environment proximate to a present location of the mobile apparatus. In an embodiment, the specified attribute of the operational environment includes the specified attribute of an environment proximate to a future location of the mobile apparatus. In an embodiment, the future location of the mobile apparatus is based upon an intended route 206 or schedule of the mobile apparatus. In an embodiment, the specified attribute of the operational environment includes a requested vantage point. In an embodiment, the specified attribute of the operational environment includes data acquired by a sensor owned or managed independently from the mobile apparatus. In an embodiment, the mobile apparatus and the responding apparatus are not related to by ownership or affiliation. In an embodiment, the mobile apparatus and the responding apparatus are not operating together or are not part of a distributed system. In an embodiment, the requested data further includes a compensation offer for the requested data. For example, the compensation offer may include an opening compensation offer or a maximum compensation offer. For example, the compensation offer may include a price the mobile apparatus is willing to pay for the data. In an embodiment, the request for data does not include a request for exclusive use of or rights in the data indicative of the specified attribute of the operational environment of the mobile apparatus. In an embodiment, the responding apparatus includes another mobile apparatus, or a stationary apparatus or system. In an embodiment, the responding apparatus includes an environmental-data exchange system.

In an embodiment, the mobile apparatus 210 includes circuitry for transmitting the request for the data indicative of the specified attribute of the operational environment 280 of the mobile apparatus, illustrated by transmitter/receiver 246 and antenna 246.1 for a wireless embodiment. In an embodiment, the circuitry for transmitting the request includes circuitry for transmitting the request to one or more possible responding apparatus 610. For example, the request may be sent directly to a responding apparatus. For example, the request may be sent a responding apparatus using an email or website accessible by the responding apparatus. For example, the request may be sent a responding apparatus using a database monitored by the responding apparatus. For example, the request may be sent to a third-party who will relay to the responding apparatus. In an embodiment, the circuitry for transmitting the request includes circuitry for transmitting the request to one or more selected possible responding apparatus.

In an embodiment of the mobile apparatus 210, the circuitry for selecting an offer 224 to supply the requested data indicative of the specified attribute of the operational environment 280 of the mobile apparatus includes selecting from respective offers submitted by at least two responding apparatus. In an embodiment, the selecting an offer to supply the requested data is at least partially based on a conformance with the request for data indicative of the specified attribute of the operational environment of the mobile apparatus. In an embodiment, the conformance may include a conformance with the specified attribute, timeliness, or confidence level. In an embodiment, the conformance may include a conformance with an offered price for the relevant data. In an embodiment, the selecting an offer to supply the requested data is at least partially based on a projected future location of the mobile apparatus or of the responding apparatus. In an embodiment, the selecting an offer to supply the requested data is at least partially based on a type or capability of a sensor carried by the responding apparatus. In an embodiment, the selecting an offer to supply the requested data is at least partially based on an available bandwidth of the responding apparatus. For example, does the responding apparatus have enough data bandwidth, etc. For example, is the responding apparatus already fully subscribed. In an embodiment, the selecting an offer to supply the requested data is at least partially based on the responding apparatus announcing its availability and its environmental-data acquisition capabilities. For example, an availability or capability may include an ability of the responding apparatus to directly broadcast to the mobile device, or an ability to post on webpage. In an embodiment, the selecting an offer to supply the requested data is at least partially based on a trustworthiness rating of the responding apparatus. In an embodiment, the selecting an offer to supply the requested data is at least partially based on a query by the mobile apparatus. In an embodiment, the selecting an offer to supply the requested data is at least partially based on information received from a third-party, such as for example a database maintained by a third-party.

In an embodiment of the mobile apparatus 210, the circuitry for forming an agreement 226 includes circuitry for forming an agreement with the responding apparatus 610 or a third party to supply the requested data. In an embodiment, the forming an agreement includes forming an agreement with the responding apparatus to supply the requested data in a financial transaction. In an embodiment, the forming an agreement includes forming an agreement with the responding apparatus to supply the requested data based upon a previous agreement. For example, a previous agreement may include an agreement among mobile apparatus to share sensor data. In an embodiment, the forming an agreement includes forming an agreement with the responding apparatus to supply the requested data and authorizing a payment for the requested data. In an embodiment, the payment may be authorized to the responding apparatus or to a third-party.

In an embodiment, the mobile apparatus 210 includes circuitry for authorizing a payment 234 for the requested data. For example, the payment may be authorized to the responding apparatus 610 or a third-party. In an embodiment, the authorizing a payment is responsive to a quality of or a verification of the received requested data.

In an embodiment, the mobile apparatus 210 includes a sensor 212 configured to acquire data indicative of an attribute of the operational environment 280 of the mobile apparatus. In an embodiment, the mobile apparatus includes circuitry for controlling the sensor 236 of the mobile apparatus. In an embodiment, the circuitry for controlling is configured to change an operation of the sensor based on the received requested data. In an embodiment, the mobile apparatus includes circuitry for receiving an offer 238 to supply the requested data indicative of the specified attribute of the operational environment of the mobile apparatus. In an embodiment, the circuitry for receiving an offer includes circuitry for receiving an offer and identifying the responding apparatus.

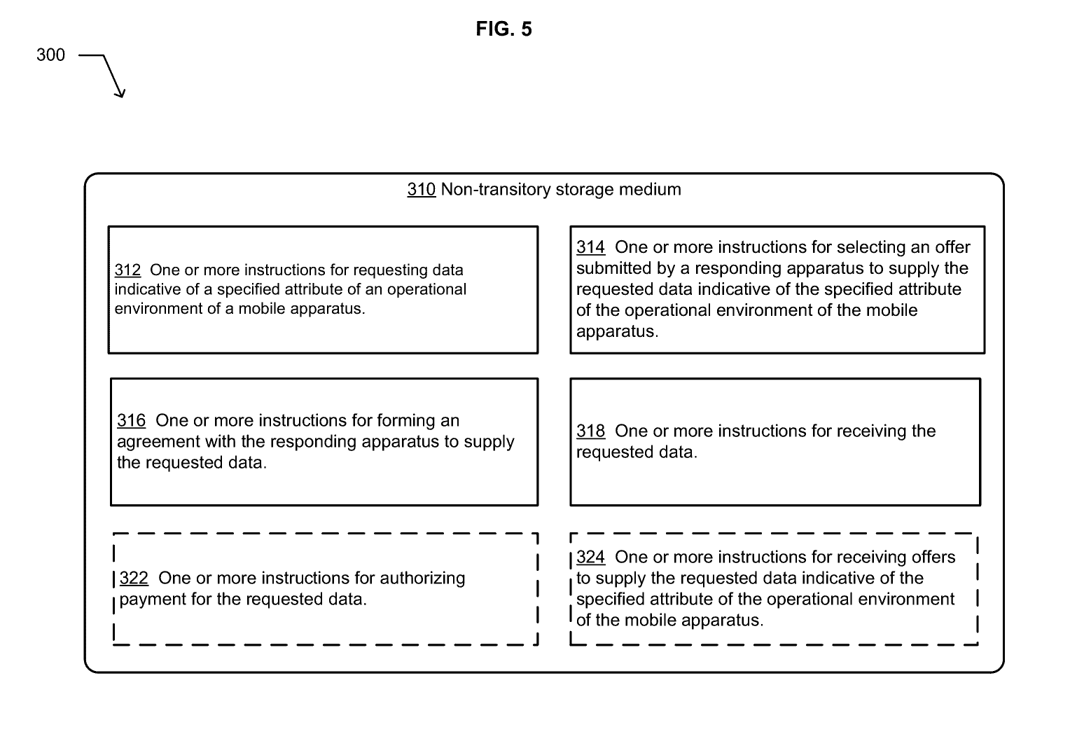

FIG. 5 illustrates an example article of manufacture 300 that includes a non-transitory storage medium 310. In an embodiment, the article of manufacture 300 may be carried by the mobile apparatus 210 described in conjunction with FIGS. 3 and 4. In an embodiment, the non-transitory storage medium includes a non-transitory computer readable storage medium. The non-transitory storage medium bears one or more instructions 312 for requesting data indicative of a specified attribute of an operational environment of a mobile apparatus. The non-transitory storage medium bears one or more instructions 314 for selecting an offer submitted by a responding apparatus to supply the requested data indicative of the specified attribute of the operational environment of the mobile apparatus. The non-transitory storage medium bears one or more instructions 316 for forming an agreement with the responding apparatus to supply the requested data. The non-transitory storage medium bears one or more instructions 318 for receiving the requested data. In an embodiment, the one or more instructions for receiving the requested data include one or more instructions for receiving the requested data from the responding apparatus or from a third-party.

In an embodiment, the non-transitory storage medium 310 bears one or more instructions 322 for authorizing payment for the requested data. In an embodiment, the one or more instructions for authorizing payment include one or more instructions for authorizing payment to the responding apparatus or a third-party. In an embodiment, the non-transitory storage medium bears one or more instructions 324 for receiving offers to supply the requested data indicative of the specified attribute of the operational environment of the mobile apparatus. In an embodiment, the non-transitory storage medium bears one or more instructions for selecting a potential responding apparatus; and wherein the one or more instructions 312 for requesting data include one or more instructions for requesting from the selected potential responding apparatus data indicative of a specified attribute of an operational environment of a mobile apparatus.

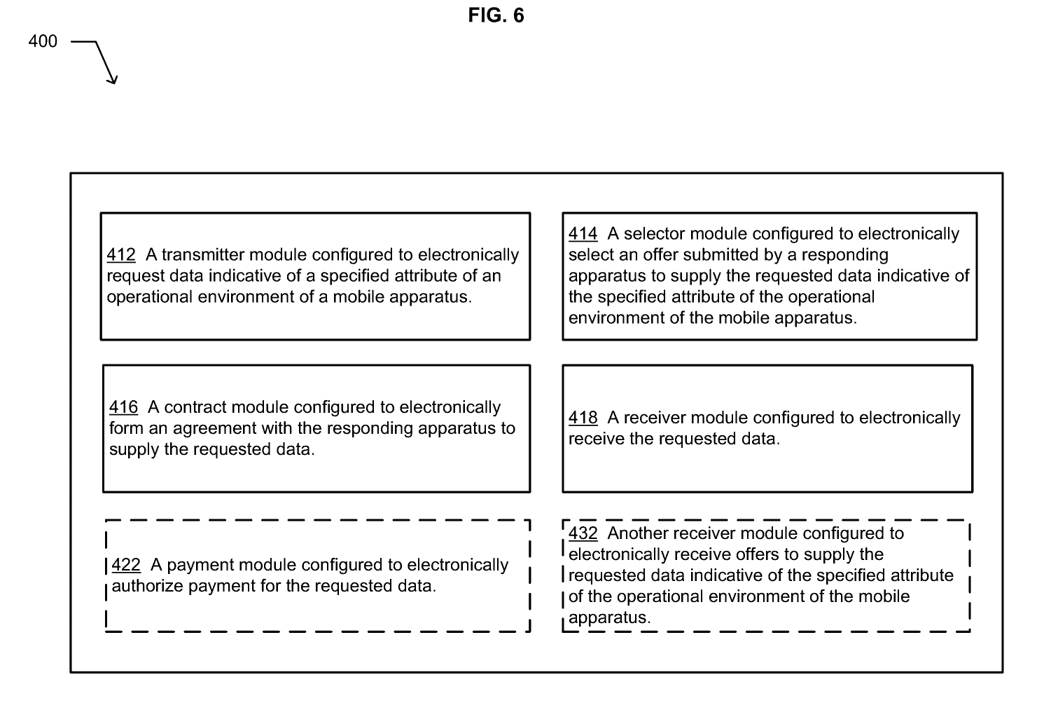

FIG. 6 illustrates an example system 400 in the form of a machine, article of manufacture, or composition of matter. In an embodiment, the system 400 may be carried by the mobile apparatus 210 described in conjunction with FIGS. 3 and 4. The system includes a transmitter module 412 configured to electronically request data indicative of a specified attribute of an operational environment of a mobile apparatus. The system includes a selector module 414 configured to electronically select an offer submitted by a responding apparatus to supply the requested data indicative of the specified attribute of the operational environment of the mobile apparatus. The system includes a contract module 416 configured to electronically form an agreement with the responding apparatus to supply the requested data. The system includes a receiver module 418 configured to electronically receive the requested data.

In an embodiment, the system 400 includes a payment module 422 configured to electronically authorize payment for the requested data. In an embodiment, the system includes another receiver module 432 configured to electronically receive offers to supply the requested data indicative of the specified attribute of the operational environment of the mobile apparatus. In an embodiment, the system includes a selector module configured to electronically select a potential responding apparatus; and wherein the transmitter module 412 is configured to electronically request from the selected potential responding apparatus data indicative of a specified attribute of an operational environment of a mobile apparatus.

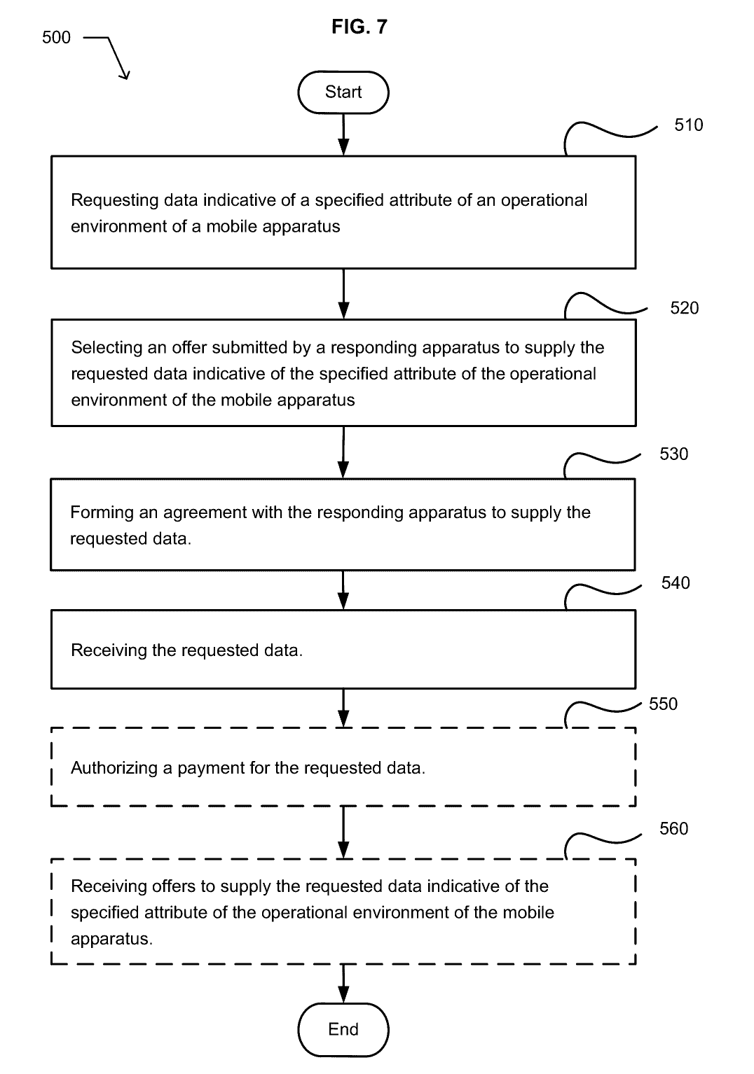

FIG. 7 illustrates computationally-implemented operational flow 500. After a start operation, the operational flow includes an invitation operation 510. The invitation operation includes requesting data indicative of a specified attribute of an operational environment of a mobile apparatus. In an embodiment, the invitation operation may be implemented using the circuitry for requesting 222 described in conjunction with FIGS. 3 and 4. A choice operation 520 includes selecting an offer submitted by a responding apparatus to supply the requested data indicative of the specified attribute of the operational environment of the mobile apparatus. In an embodiment, the responding apparatus includes a senor equipped responding apparatus. In an embodiment, the responding apparatus includes a system for exchanging environmental data. In an embodiment, the choice operation may be implemented using the circuitry for selecting 224 an offer described in conjunction with FIGS. 3 and 4. A contract operation 530 includes forming an agreement with the responding apparatus to supply the requested data. In an embodiment, the contract operation may be implemented using the circuitry for forming 226 an agreement described in conjunction with FIGS. 3 and 4. A reception operation 540 includes receiving the requested data. In an embodiment, the requested data may be received from the responding apparatus or from a third-party. In an embodiment, the reception operation may be implemented using the circuitry for receiving 228 the requested data described in conjunction with FIGS. 3 and 4.

In an embodiment, the operational flow 550 includes authorizing 550 a payment for the requested data. In an embodiment, the operational flow includes receiving 560 offers to supply the requested data indicative of the specified attribute of the operational environment of the mobile apparatus. In an embodiment, the operational flow includes selecting a potential responding apparatus; and wherein the invitation operation 510 includes requesting from the selected potential responding apparatus data indicative of a specified attribute of an operational environment of the mobile apparatus.

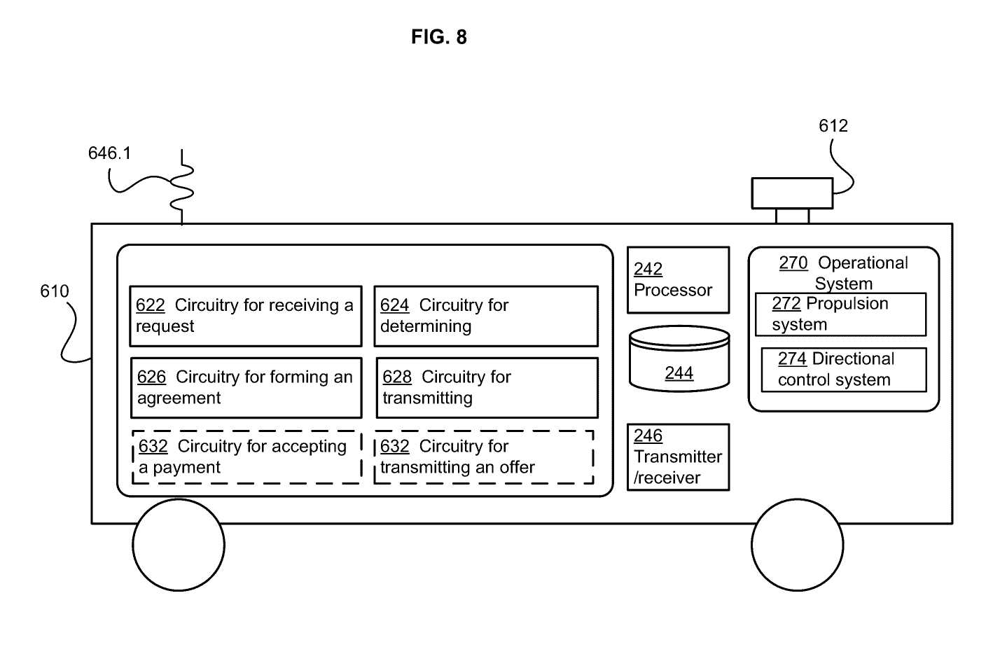

FIG. 8 illustrates an example of the responding apparatus 610 described in conjunction with FIGS. 3 and 4. The responding apparatus 610 includes a sensor 612 configured to acquire data indicative of an attribute of an environment of the responding apparatus. In an embodiment, the sensor is configured to acquire data indicative of an attribute of the environment that is a distance from the responding apparatus, such as radar data, infrared data, or optical data. The responding apparatus includes circuitry for receiving a request 622 originated by an inquiring mobile apparatus for data indicative of a specified attribute of the environment of the sensor-equipped apparatus. For example, the request may be originated by the mobile apparatus 210 described in conjunction with FIGS. 3 and 4. For example, the request may be originated by the environmental-data exchange 810 described in conjunction with FIGS. 10 and 11. The responding apparatus includes circuitry for determining 624 if data acquired by the sensor is indicative of the specified attribute of the environment. In an embodiment, the circuitry for determining is configured for determining if data acquired by the sensor is indicative of the specified attribute of the environment complies with the received request. The responding apparatus includes circuitry for forming an agreement 626 to supply the requested data indicative of the specified attribute of the environment. In an embodiment, the circuitry for forming includes circuitry for forming an agreement with the initiating apparatus or an environmental data exchange system to supply the requested data indicative of the specified attribute of the environment. The responding apparatus includes circuitry for transmitting 628 the requested data indicative of the specified attribute of the environment. In an embodiment, the circuitry for transmitting includes circuitry for transmitting the requested data indicative of the specified attribute of the environment to the initiating apparatus or to the management system.

In an embodiment, the circuitry for forming an agreement 626 further includes circuitry for forming an agreement establishing a price for the requested data. In an embodiment, the responding apparatus 610 includes circuitry for accepting a payment 632 for the requested data. In an embodiment, the responding apparatus includes circuitry for transmitting an offer 632 to supply the requested data indicative of the specified attribute of the environment. In an embodiment, the circuitry for transmitting an offer 632 to supply the requested data indicative of the specified attribute of the environment at a specified price. In an embodiment, the responding apparatus includes circuitry for spoofing the inquiring apparatus if the apparatus determines the request for data is from a malicious inquiring apparatus. In an embodiment, the responding apparatus includes circuitry for receiving payment for the requested data. In an embodiment, the circuitry for receiving payment includes circuitry for receiving payment from the initiating apparatus or a third-party for the requested data.

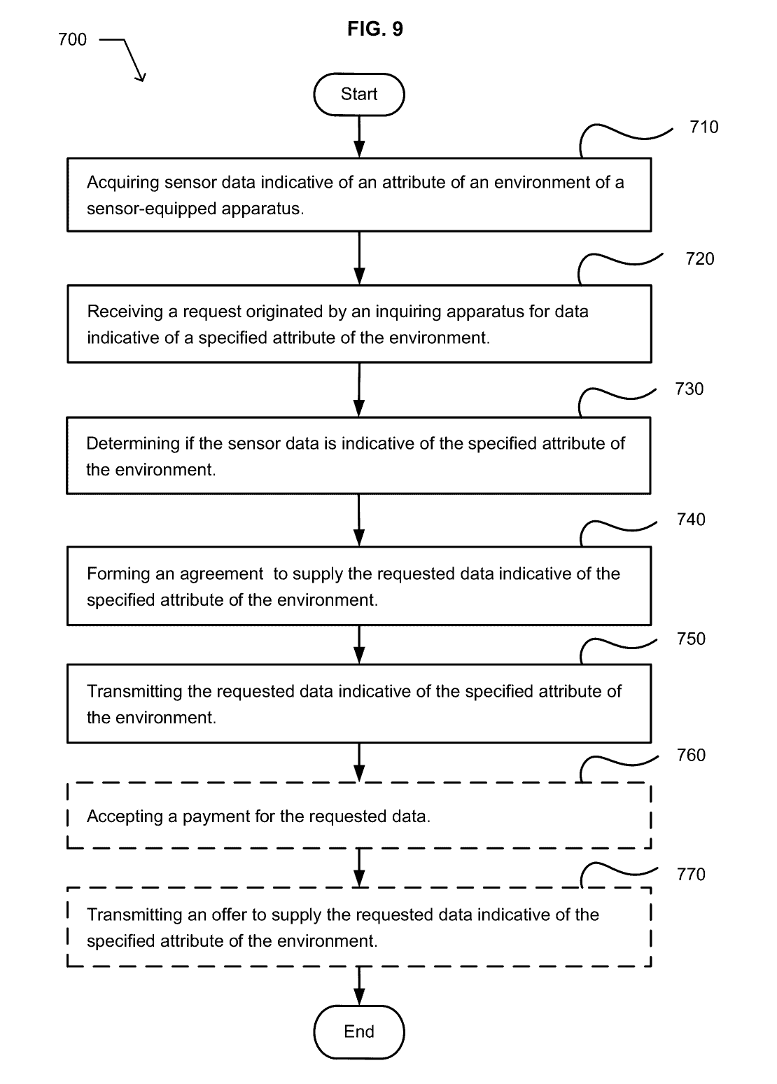

FIG. 9 illustrates an example computationally-implemented operational flow 700. After a start operation, the computationally-implemented operational flow includes an environmental-data acquisition operation 710. The acquisition operation includes acquiring sensor data indicative of an attribute of an environment of a sensor-equipped apparatus. In an embodiment, the environmental-data acquisition operation may be implemented using the sensor 612 of the responding apparatus 610 described in conjunction with FIG. 8. A reception operation 720 includes receiving a request originated by an inquiring apparatus for data indicative of a specified attribute of the environment. In an embodiment, the request may be originated by an inquiring apparatus. In an embodiment, the request may be received from the inquiring apparatus or from an environmental-data exchange system. In an embodiment, the reception operation may be implemented using the circuitry for receiving a request 622 described in conjunction with FIG. 8. A compliance operation 730 includes determining if the sensor data is indicative of the specified attribute of the environment. In an embodiment, the compliance operation may be implemented using the circuitry for determining 624 described in conjunction with FIG. 8. A contract operation 740 includes forming an agreement to supply the requested data indicative of the specified attribute of the environment. In an embodiment, the contract agreement may be implemented using the circuitry for forming 626 described in conjunction with FIG. 8. A fulfillment operation 750 includes transmitting the requested data indicative of the specified attribute of the environment. In an embodiment, the fulfillment operation may be implemented using the circuitry for transmitting 628 described in conjunction with FIG. 8. The operational flow includes an end operation.

In an embodiment, the computationally-implemented operational flow 700 includes accepting a payment 760 for the requested data. In an embodiment, the computationally-implemented operational includes transmitting an offer 770 to supply the requested data indicative of the specified attribute of the environment.

FIG. 10 schematically illustrates an alternative embodiment 800 of the example environment 200 in which embodiments may be implemented. The alternative environment of the example environment includes the mobile apparatus 210, the responding apparatus 610, and an environmental-data exchange system 810.

FIG. 11 schematically illustrates an example of the environmental-data exchange system 810. The environmental-data exchange system includes circuitry for receiving a data request 822 originated by a requesting mobile apparatus 210. The data request including a request for data indicative of a specified attribute of an operational environment 280 of the requesting mobile apparatus. The environmental-data exchange system includes circuitry for receiving a data offer 824 originated by a responding apparatus, illustrated by the responding mobile apparatus 610. The data offer including supplying the requested data indicative of the specified attribute of the operational environment of the requesting mobile apparatus. The environmental-data exchange system includes circuitry for forming an agreement 826 between the requesting mobile apparatus and the responding apparatus. The agreement including the responding apparatus transmitting the requested data indicative of the specified attribute of the environment in exchange for compensation. The environmental-data exchange system includes circuitry for initiating implementation 828 of the agreement between the requesting mobile apparatus and the responding apparatus.

In an embodiment of the environmental-data exchange system 810, the data request includes a request for sensor acquired data indicative of the operational environment 280 of the requesting mobile apparatus 210. For example, the operational environment may include a prior, present, or future operational environment of the requesting mobile apparatus. In an embodiment, the data request includes a request for a specified timeliness of the data. In an embodiment, the data request includes a compensation request for the requested data. For example, the compensation may include a fixed, an opening offer, or a maximum compensation. In an embodiment, the data offer includes a compensation request for the requested data. For example, the compensation request may include a fixed, an opening offer, or a maximum compensation.

In an embodiment, the environmental-data exchange system 810 includes circuitry for sending 832 a data request. The sent data request including data indicative of the specified attribute of the operational environment 280 of the requesting mobile apparatus 210. In an embodiment, the data request may be sent wirelessly directly from the data-exchange system to a receiving apparatus, such as a mobile, stationary, or fixed-base apparatus. In an embodiment, the data request may be sent using a cellular network from the data-exchange system to a receiving apparatus, such as a mobile, stationary, or fixed-base apparatus. In an embodiment, the data request may be sent using a network, such as a private or public network (e.g. Internet) from the data-exchange system to a receiving apparatus, such as a mobile, stationary, or fixed-base apparatus. In an embodiment, the sending a data request includes broadcasting the data request to at least two potential responding apparatus. In an embodiment, a potential responding apparatus includes a mobile apparatus. In an embodiment, a potential responding apparatus includes a stationary apparatus.

In an embodiment, the environmental-data exchange system 810 includes circuitry for searching a database 834 of respective offers of data directed to a particular attribute of a particular environment originated by at least two responding apparatus for a conformance with the mobile apparatus data request. In this embodiment, the circuitry for forming an agreement 826 includes circuitry for forming an agreement between the requesting mobile apparatus 210 and the responding apparatus 610 that offered the data conforming to the data request. In an embodiment, the database may be locally stored on a computer-readable media, illustrated by a storage device 844. For example, the database may be a centralized database or a third-party database. For example, the database may include a current location of the responding apparatus 610 and a current location of a stationary responding apparatus. For example, the database may include sensor capabilities of the responding apparatus.

In an embodiment, the circuitry for forming an agreement 826 includes circuitry for forming an agreement between the requesting mobile apparatus 210 and a selected responding apparatus. In an embodiment, the circuitry for forming an agreement includes circuitry for forming an agreement that includes the responding apparatus transmitting the requested data indicative of the specified attribute of the environment to the initiating apparatus in exchange for compensation. For example, the compensation may be contracted by or authorized by the requesting mobile apparatus, or by the environmental-data exchange system. In an embodiment, the circuitry for forming an agreement includes circuitry for forming an agreement that includes the responding apparatus transmitting the requested data indicative of the specified attribute of the environment to the management system in exchange for the compensation.

In an embodiment, the environmental-data exchange system 810 includes circuitry for initiating 836 a transfer of the compensation to the responding apparatus or the system. In an embodiment, the environmental-data exchange system includes circuitry for selecting an offer 838 to supply the requested data originated by a responding apparatus of at least two responding apparatus. In this embodiment, the circuitry for forming an agreement 826 includes circuitry for forming an agreement between the requesting mobile apparatus and the responding apparatus originating the selected offer to supply the requested data. In an embodiment, the circuitry for selecting an offer 838 includes circuitry to select an offer to supply the requested data at least partially based on a conformance with the mobile apparatus data request.

In an embodiment, the environmental-data exchange system 810 includes circuitry for transmitting or receiving signals via a network 890, illustrated by a transmitter/receiver 846 and antenna 846.1 for a wireless embodiment. In an embodiment, the network communicates wirelessly 892 with the requesting apparatus 210 or the responding apparatus 610. In an embodiment, the environmental-data exchange system includes a central processing unit or processor 842. For example, the processor may be similar to the processing unit 21 described in conjunction with FIG. 1. In an embodiment, the environmental-data exchange system may include at least one element or component of the thin computing device 20 described in conjunction with FIG. 1. For example, the processor may be similar to the processor 120 described in conjunction with FIG. 2. In an embodiment, the environmental-data exchange system may include at least one element or component of the general purpose computing system 110 described in conjunction with FIG. 2.

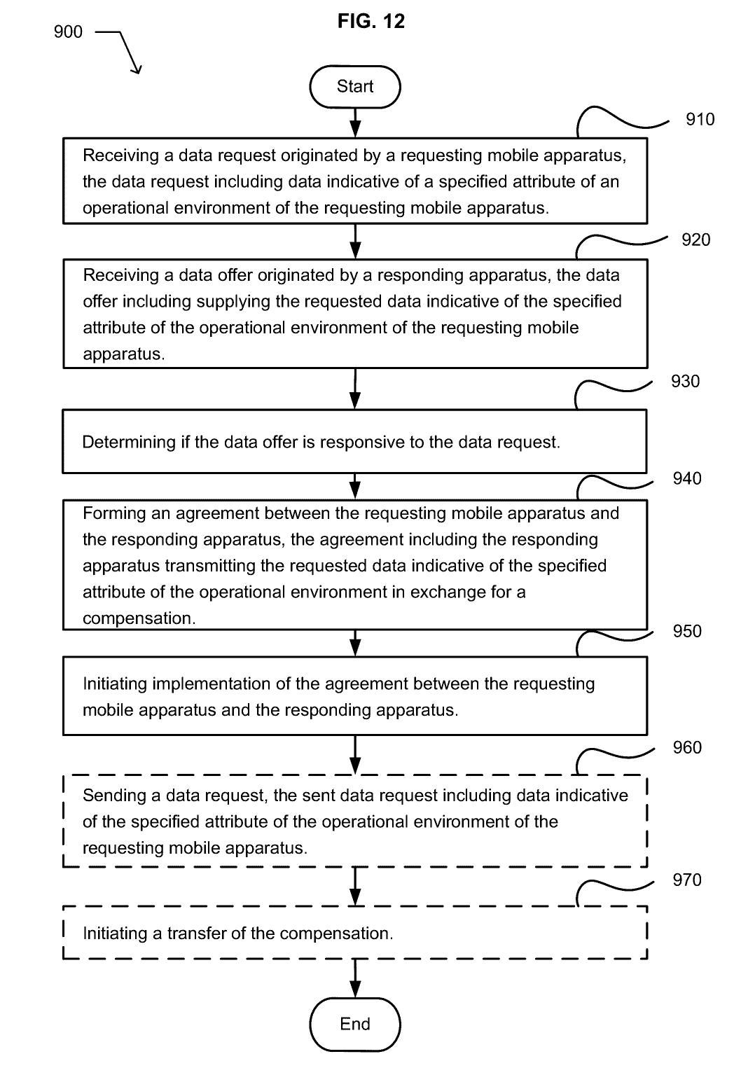

FIG. 12 illustrates an example computationally-implemented operational flow 900. After a start operation, the operational flow includes a first reception operation 910 that includes receiving a data request originated by a requesting mobile apparatus. The data request including data indicative of a specified attribute of an operational environment of the requesting mobile apparatus. In an embodiment, the first reception operation may be implemented using the circuitry for receiving a data request 822 described in conjunction with FIG. 11. The operational flow includes a second reception operation 920 that includes receiving a data offer originated by a responding apparatus. The data offer includes supplying the requested data indicative of the specified attribute of the operational environment of the requesting mobile apparatus. In an embodiment, the second reception operation may be implemented using the circuitry for receiving a data offer 824. A compliance operation 930 includes determining if the data offer is responsive to the data request. In an embodiment, the compliance operation may be implemented using the circuitry for selecting an offer 838 described in conjunction with FIG. 11. A contract operation 940 includes forming an agreement between the requesting mobile apparatus and the responding apparatus. The agreement including the responding apparatus transmitting the requested data indicative of the specified attribute of the operational environment in exchange for compensation. In an embodiment, the contract operation may be implemented using the circuitry for forming an agreement 826 described in conjunction with FIG. 11. A fulfilment operation 950 includes initiating implementation of the agreement between the requesting mobile apparatus and the responding apparatus. In an embodiment, the fulfilment operation may be implemented using the circuitry for initiating implementation 828. The operational flow includes an end operation.

In an embodiment, the operational flow 900 includes a query operation 960 sending a data request. The sent data request including a request for data indicative of the specified attribute of the operational environment of the requesting mobile apparatus. In an embodiment, the operational flow includes searching a database of respective offers of data directed to a particular attribute of a particular environment originated by at least two responding apparatus for a conformance with the mobile apparatus data request. In this embodiment, the contract operation 940 includes forming an agreement between the requesting mobile apparatus and the responding apparatus that offered the data conforming to the data request. In an embodiment, the operational flow includes an operation 970 initiating a transfer of the compensation to the responding apparatus or the system. In an embodiment, the operational flow includes selecting an offer to supply the requested data originated by a responding apparatus of at least two responding apparatus. In this operation, the contract operation includes forming an agreement between the requesting mobile apparatus and the responding apparatus originating the selected offer to supply the requested data.

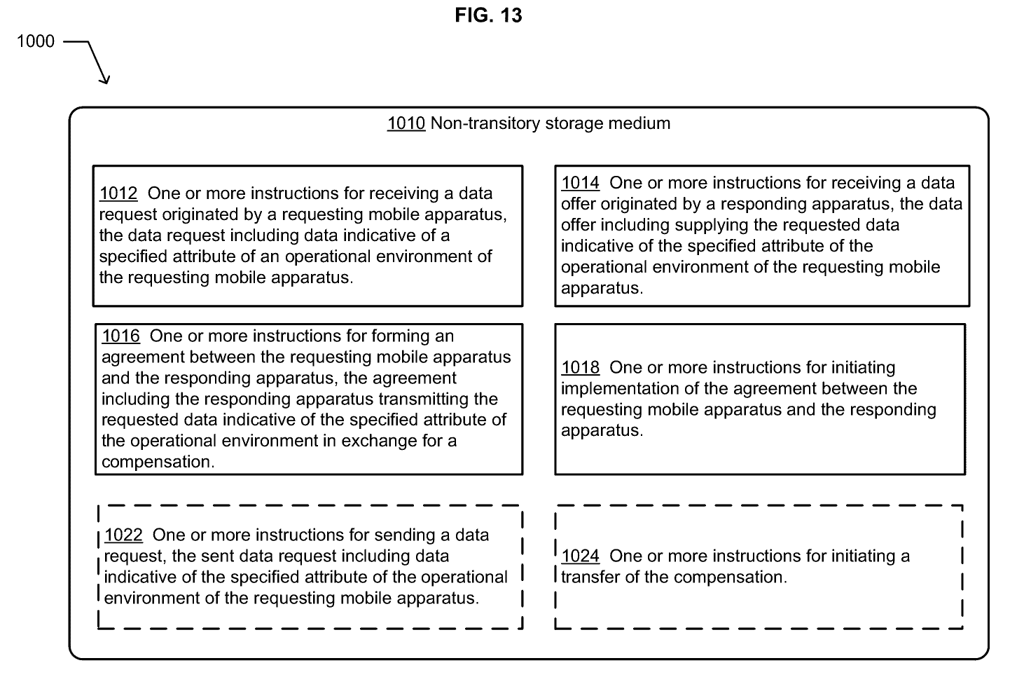

FIG. 13 illustrates an example article of manufacture 1000 that includes a non-transitory storage medium 1010. In an embodiment, the non-transitory storage medium includes a non-transitory computer readable storage medium. The non-transitory storage medium bears one or more instructions for receiving a data request 1012 originated by a requesting mobile apparatus. The data request including data indicative of a specified attribute of an operational environment of the requesting mobile apparatus. The non-transitory storage medium bears one or more instructions for receiving a data offer 1014 originated by a responding apparatus. The data offer including supplying the requested data indicative of the specified attribute of the operational environment of the requesting mobile apparatus. The non-transitory storage medium bears one or more instructions for forming an agreement 1016 between the requesting mobile apparatus and the responding apparatus. The agreement including the responding apparatus transmitting the requested data indicative of the specified attribute of the operational environment in exchange for compensation. The non-transitory storage medium bears one or more instructions for initiating implementation of the agreement 1018 between the requesting mobile apparatus and the responding apparatus.

In an embodiment, the non-transitory storage medium 1010 bears one or more instructions for sending a data request 1022. The sent data request including data indicative of the specified attribute of the operational environment of the requesting mobile apparatus. In an embodiment, the non-transitory storage medium bears one or more instructions for searching a database of respective offers of data directed to a particular attribute of a particular environment originated by at least two responding apparatus for a conformance with the mobile apparatus data request. In this embodiment, the one or more instructions for forming an agreement 1016 include one or more instructions for forming an agreement between the requesting mobile apparatus and the responding apparatus that offered the data conforming to the data request. In an embodiment, the non-transitory storage medium bears one or more instructions for initiating a transfer 1024 of the compensation. In an embodiment, the non-transitory storage medium bears one or more instructions for selecting an offer to supply the requested data originated by a responding apparatus of at least two responding apparatus. In this embodiment, the one or more instructions for forming an agreement include one or more instructions for forming an agreement between the requesting mobile apparatus and the responding apparatus originating the selected offer to supply the requested data.

An example embodiment includes a system in the form of a machine, article of manufacture, or composition of matter. The system includes a first receiver module configured to electronically receive a data request originated by a requesting mobile apparatus. The data request including data indicative of a specified attribute of an operational environment of the mobile apparatus. The system includes a second receiver module configured to electronically receive a data offer originated by a responding apparatus. The data offer including supplying the requested data indicative of the specified attribute of the operational environment of the requesting mobile apparatus. The system includes a contract module configured to electronically form an agreement between the requesting mobile apparatus and the responding apparatus, the agreement including the responding apparatus transmitting the requested data indicative of the specified attribute of the environment in exchange for compensation. The system includes a fulfillment module configured to electronically initiate implementation of the agreement between the requesting mobile apparatus and the responding apparatus.

All references cited herein are hereby incorporated by reference in their entirety or to the extent their subject matter is not otherwise inconsistent herewith.

In some embodiments, “configured” includes at least one of designed, set up, shaped, implemented, constructed, or adapted for at least one of a particular purpose, application, or function.

It will be understood that, in general, terms used herein, and especially in the appended claims, are generally intended as “open” terms. For example, the term “including” should be interpreted as “including but not limited to.” For example, the term “having” should be interpreted as “having at least.” For example, the term “has” should be interpreted as “having at least.” For example, the term “includes” should be interpreted as “includes but is not limited to,” etc. It will be further understood that if a specific number of an introduced claim recitation is intended, such an intent will be explicitly recited in the claim, and in the absence of such recitation no such intent is present. For example, as an aid to understanding, the following appended claims may contain usage of introductory phrases such as “at least one” or “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a receiver” should typically be interpreted to mean “at least one receiver”); the same holds true for the use of definite articles used to introduce claim recitations. In addition, even if a specific number of an introduced claim recitation is explicitly recited, it will be recognized that such recitation should typically be interpreted to mean at least the recited number (e.g., the bare recitation of “at least two chambers,” or “a plurality of chambers,” without other modifiers, typically means at least two chambers).

In those instances where a phrase such as “at least one of A, B, and C,” “at least one of A, B, or C,” or “an [item] selected from the group consisting of A, B, and C,” is used, in general such a construction is intended to be disjunctive (e.g., any of these phrases would include but not be limited to systems that have A alone, B alone, C alone, A and B together, A and C together, B and C together, or A, B, and C together, and may further include more than one of A, B, or C, such as A₁, A₂, and C together, A, B₁, B₂, C₁, and C₂ together, or B₁ and B₂ together). It will be further understood that virtually any disjunctive word or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The herein described aspects depict different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality. Any two components capable of being so associated can also be viewed as being “operably couplable” to each other to achieve the desired functionality. Specific examples of operably couplable include but are not limited to physically mateable or physically interacting components or wirelessly interactable or wirelessly interacting components.

With respect to the appended claims the recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Use of “Start,” “End,” “Stop,” or the like blocks in the block diagrams is not intended to indicate a limitation on the beginning or end of any operations or functions in the diagram. Such flowcharts or diagrams may be incorporated into other flowcharts or diagrams where additional functions are performed before or after the functions shown in the diagrams of this application. Furthermore, terms like “responsive to,” “related to,” or other past-tense adjectives are generally not intended to exclude such variants, unless context dictates otherwise.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. An environmental-data exchange system comprising:
circuitry for receiving a data request originated by a requesting mobile apparatus, the data request including data indicative of a specified attribute of an operational environment of the requesting mobile apparatus;
circuitry for receiving a data offer originated by a responding apparatus, the data offer including supplying the requested data indicative of the specified attribute of the operational environment of the requesting mobile apparatus;
circuitry for forming an agreement between the requesting mobile apparatus and the responding apparatus, the agreement including the responding apparatus transmitting the requested data indicative of the specified attribute of the environment in exchange for a compensation; and
circuitry for initiating implementation of the agreement between the requesting mobile apparatus and the responding apparatus.

2. The system of claim 1, wherein the data request includes a request for sensor acquired data indicative of the operational environment of the requesting mobile apparatus.

3. The system of claim 1, wherein the data request includes a specified timeliness of the data.

4. The system of claim 1, wherein the data request includes a compensation request for the requested data.

5. The system of claim 1, wherein the data offer includes a compensation request for the requested data.

6. The system of claim 1, further comprising:
circuitry for sending a data request, the sent data request including data indicative of the specified attribute of the operational environment of the requesting mobile apparatus.

7. The system of claim 6, wherein the sending a data request includes broadcasting the data request to at least two potential responding apparatus.

8. The system of claim 6, wherein a potential responding apparatus includes a mobile apparatus.

9. The system of claim 6, wherein a potential responding apparatus includes a stationary apparatus.

10. The system of claim 1, further comprising:
circuitry for searching a database of respective offers of data directed to a particular attribute of a particular environment originated by at least two responding apparatus for a conformance with the mobile apparatus data request; and
wherein the circuitry for forming an agreement includes circuitry for forming an agreement between the requesting mobile apparatus and the responding apparatus that offered the data conforming to the data request.

11. The system of claim 1, wherein the forming an agreement includes forming an agreement between the requesting mobile apparatus and a selected responding apparatus.

12. The system of claim 1, wherein the forming an agreement includes forming an agreement that includes the responding apparatus transmitting the requested data indicative of the specified attribute of the environment to the initiating apparatus in exchange for a compensation.

13. The system of claim 1, wherein the forming an agreement includes forming an agreement that includes the responding apparatus transmitting the requested data indicative of the specified attribute of the operational environment to the management system in exchange for the compensation.

14. The system of claim 1, further comprising:
circuitry for initiating a transfer of the compensation to the responding apparatus or the system.

15. The system of claim 1, further comprising:
circuitry for selecting an offer to supply the requested data originated by a responding apparatus of at least two responding apparatus; and
wherein the circuitry for forming an agreement includes circuitry for forming an agreement between the requesting mobile apparatus and the responding apparatus originating the selected offer to supply the requested data.

16. The system of claim 15, wherein the selecting an offer to supply the requested data is at least partially based on a conformance with the mobile apparatus data request.

17. A computationally-implemented method comprising:
receiving a data request originated by a requesting mobile apparatus, the data request including data indicative of a specified attribute of an operational environment of the requesting mobile apparatus;
receiving a data offer originated by a responding apparatus, the data offer including supplying the requested data indicative of the specified attribute of the operational environment of the requesting mobile apparatus;
determining if the data offer is responsive to the data request;
forming an agreement between the requesting mobile apparatus and the responding apparatus, the agreement including the responding apparatus transmitting the requested data indicative of the specified attribute of the operational environment in exchange for a compensation; and
initiating implementation of the agreement between the requesting mobile apparatus and the responding apparatus.

18. The method of claim 17, further comprising:
sending a data request, the sent data request including data indicative of the specified attribute of the operational environment of the requesting mobile apparatus.

19. The method of claim 17, further comprising:
searching a database of respective offers of data directed to a particular attribute of a particular environment originated by at least two responding apparatus for a conformance with the mobile apparatus data request; and
wherein the forming an agreement includes forming an agreement between the requesting mobile apparatus and the responding apparatus that offered the data conforming to the data request.

20. The method of claim 17, further comprising:
initiating a transfer of the compensation.

21. The method of claim 17 further comprising:
selecting an offer to supply the requested data originated by the responding apparatus of at least two responding apparatus; and
wherein the forming an agreement includes forming an agreement between the requesting mobile apparatus and the responding apparatus originating the selected offer to supply the requested data.

22. An article of manufacture, comprising:
a non-transitory storage medium bearing:
one or more instructions for receiving a data request originated by a requesting mobile apparatus, the data request including data indicative of a specified attribute of an operational environment of the requesting mobile apparatus;
one or more instructions for receiving a data offer originated by a responding apparatus, the data offer including supplying the requested data indicative of the specified attribute of the operational environment of the requesting mobile apparatus;
one or more instructions for forming an agreement between the requesting mobile apparatus and the responding apparatus, the agreement including the responding apparatus transmitting the requested data indicative of the specified attribute of the operational environment in exchange for a compensation; and
one or more instructions for initiating implementation of the agreement between the requesting mobile apparatus and the responding apparatus.

23. The article of manufacture of claim 22, further comprising:
the non-transitory storage medium bearing one or more instructions for sending a data request, the sent data request including data indicative of the specified attribute of the operational environment of the requesting mobile apparatus.

24. The article of manufacture of claim 22, further comprising:
the non-transitory storage medium bearing one or more instructions for searching a database of respective offers of data directed to a particular attribute of a particular environment originated by at least two responding apparatus for a conformance with the mobile apparatus data request; and
wherein the one or more instructions for forming an agreement include one or more instructions for forming an agreement between the requesting mobile apparatus and the responding apparatus that offered the data conforming to the data request.

25. The article of manufacture of claim 22, further comprising:
the non-transitory storage medium bearing one or more instructions for initiating a transfer of the compensation.

26. The article of manufacture of claim 22, further comprising:
the non-transitory storage medium bearing one or more instructions for selecting an offer to supply the requested data originated by the responding apparatus of at least two responding apparatus; and
wherein the one or more instructions for forming an agreement include one or more instructions for forming an agreement between the requesting mobile apparatus and the responding apparatus originating the selected offer to supply the requested data.

27. A system in the form of a machine, article of manufacture, or composition of matter comprising:
a first receiver module configured to electronically receive a data request originated by a requesting mobile apparatus, the data request including data indicative of a specified attribute of an operational environment of the requesting mobile apparatus;
a second receiver module configured to electronically receive a data offer originated by a responding apparatus, the data offer including supplying the requested data indicative of the specified attribute of the operational environment of the requesting mobile apparatus;
a contract module configured to electronically form an agreement between the requesting mobile apparatus and the responding apparatus, the agreement including the responding apparatus transmitting the requested data indicative of the specified attribute of the operational environment in exchange for a compensation; and
a fulfillment module configured to electronically initiate implementation of the agreement between the requesting mobile apparatus and the responding apparatus.
